(19) United States
(12) Patent Application Publication
(10) Pub. No.: US 2023/0003177 A1
(43) Pub. Date: Jan. 5, 2023

(54) FIBER REINFORCED POLYMER COMPOSITE STRUCTURES AND ELECTROMAGNETIC INDUCTION PROCESS FOR MAKING SAME

(71) Applicants: Government of the United States, represented by the Secretary of the Air Force, Wright-Patterson AFB, OH (US); Government of Japan, as represented by the Commissioner of the Acquisition, Technology and Logistics, Tokyo (JP); IHI Aerospace Co., Ltd., Tokyo (JP)

(72) Inventors: Gregory R. YANDEK, Wright-Patterson AFB, OH (US); Takayuki EDANAGA, Tokyo (JP); Seiki HASHINO, Tokyo (JP); Hiroshi SATO, Tokyo (JP); Masaaki SATAKE, Tokyo (JP); Masanori SAKAINO, Tokyo (JP)

(73) Assignees: Government of the United States, represented by the Secretary of the Air Force, Wright-Patterson AFB, OH (US); Government of Japan, as represented by the Commissioner of the Acquisition, Technology and Logistics, Tokyo (JP); IHI Aerospace Co., Ltd., Tokyo (JP)

(21) Appl. No.: 17/779,954

(22) PCT Filed: Nov. 19, 2020
(86) PCT No.: PCT/JP2020/043228

§ 371 Date: May 25, 2022

Related U.S. Application Data
(60) Provisional application No. 62/940,830, filed on Nov. 26, 2019.

(51) Int. Cl. F02K 9/10; C08G 73/06; C08G 73/12; C08J 5/04; C08J 5/24; B29C 70/32

(52) U.S. Cl. CPC F02K 9/10; C08G 73/065; C08G 73/12; C08J 5/042; C08J 5/243; B29C 70/32; C08J 2363/00; C08J 2379/00; B29K 2079/085

(57) ABSTRACT

The present invention relates to resin compositions, fiber reinforced polymeric structures and electromagnetic induction processes for making same. Such magnetic induction processes are pulsed processes that can be optionally coupled with cooling steps between pulses. The aforementioned fiber reinforced polymeric structures can take forms that include, but are not limited to, pipes; pressure vessels, including rocket motor cases and fire extinguishers; golf club shafts; tennis and badminton racquets; skis; snowboards; hockey sticks; fishing rods; bicycle frames; boat masts; oars; paddles; baseball bats; and softball bats. In addition, such fiber reinforced polymeric structures can be supplemented with other materials, such as a rocket propellant, to form articles, for example, a rocket motor.

### CROSS REFERENCE TO RELATED APPLICATION

This application claims priority to U.S. Provisional Patent Application Ser. No. 62/940,830 filed on Nov. 26, 2019, which are all incorporated by reference as if fully set forth.

### RIGHTS OF THE GOVERNMENT

This invention was made with Government support from the U.S. Air Force. The Government of the United States has the right to practice or have practiced on behalf of the United States this subject invention in all countries.

### FIELD OF THE INVENTION

The present invention relates to polymer composites, fiber reinforced polymer composite structures, and electromagnetic induction processing for making same, and the use of such cases as pressure vessels, rocket cases, athletic goods, pipe, and other lightweight structural components.

### BACKGROUND OF THE INVENTION

Fiber reinforced polymeric structures are produced by processes that typically require oven curing of the adhesive polymeric resin system comprising such structures. The use of high temperature resin systems is desired as such systems can impart high temperature strength to the resulting fiber reinforced polymeric structures. Unfortunately, when a high temperature resin is employed, processes are limited to articles that do not contain a heat sensitive material, such as a rocket propellant, because high oven temperatures are required to cure such resins and such elevated temperatures impart excessive thermal energy to the heat sensitive materials. Excessive thermal energy can lead to decomposition of heat sensitive materials or even auto ignition of such heat sensitive materials in the specific case of rocket propellant, creating the conditions for an explosive event.

Applicants recognized that the source of the problem was not only the amount of thermal energy provided by a curing oven but even more importantly the rate at which such thermal energy is applied. In short, Applicants recognized that the true source of the problem was the lack of thermal control afforded by typical resin curing methods. Applicants discovered that controlled thermal curing of resins systems having a broad range of curing temperatures could be achieved, without imparting excessive thermal energy to heat sensitive materials, by electromagnetic induction processes that are pulsed processes that can be optionally coupled with cooling steps between pulses.

Thus, Applicants disclose electromagnetic induction processes that are pulsed processes that can be optionally coupled with cooling steps between pulses, fiber reinforced polymeric structural cases made by such processes, and articles comprising such cases, as well as methods of using such cases and articles.

### SUMMARY OF THE INVENTION

The present invention relates to resin compositions, fiber reinforced polymeric structures, and electromagnetic induction processes for making same. Such electromagnetic induction processes may be pulsed processes that can be optionally coupled with cooling steps between pulses. The aforementioned fiber reinforced polymeric structures can take forms that include, pipes; pressure vessels, including rocket motor cases and fire extinguishers; golf club shafts; tennis and badminton racquets; skis; snowboards; hockey sticks; fishing rods; bicycle frames; boat masts; oars; paddles; baseball bats; and softball bats. In addition, such fiber reinforced polymeric structures can be supplemented with other materials, such as a rocket propellant, to form articles, for example, a rocket motor.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic of basic components of an induction heating system.

FIG. 2 is a schematic of the principles of magnetic induction heating of a fiber reinforced polymer composite case.

FIG. 3 is a schematic of a continuous solenoid coil that is conformed to the dome regions of the fiber reinforced polymer composite case such that the spacing between the coil and the case is constant.

FIG. 4 is a depiction of 3 turn solenoid coil in linear translation movement over the cylindrical region of a fiber reinforced polymer composite case.

FIG. 5 is a depiction of single lobe axial coil positioned over a fiber reinforced case.

FIGS. 6A and 6B depict a single lobe axial coil positioned over a fiber reinforced polymer case, tilted at an angle α that is parallel with direction of the fiber tows in the helical and/or polar layers.

FIG. 7 is a depiction of single lobe axial coil positioned over a fiber reinforced polymer case, with ends shape conformed to the surfaces of the dome section contours.

FIG. 8 is a depiction of multi-lobe axial coil positioned over the cylindrical region of a fiber reinforced polymer case.

FIG. 9 is a depiction of a hybrid coil featuring both solenoid and axial elements in series.

FIG. 10 is a depiction of cross section of insulated fiber reinforced polymer rocket motor case.

FIGS. 11A through 11F depict non-limiting structures of thermosetting resin monomers and catalysts that are amenable to electromagnetic induction heating processing of fiber reinforced polymer cases.

FIGS. 12A through 12C depict non-limiting structures of cyanate ester resins and cure catalyst systems found to be effective for pulse electromagnetic induction cure processing.

FIG. 13 depicts a fiber reinforced polymer composite paddle comprising a resin. The paddle is surrounded by a coil. The resin can be cured by energizing the coil.

FIG. 14 is a graph showing the effect of cyanate ester resin composition and catalyst type on the interlaminar shear strength of carbon fiber reinforced polymer composites at a testing temperature of 200 degrees Celsius.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

### Definitions

As used herein, “fiber reinforced polymer composite structures” include pipes; pressure vessels, including rocket motor cases and fire extinguishers; golf club shafts; tennis and badminton racquets; skis; snowboards; hockey sticks; fishing rods; bicycle frames; boat masts; oars; paddles; baseball bats; and softball bats.

Unless specifically stated otherwise, as used herein, the terms “a”, “an” and “the” mean “at least one”.

As used herein, the terms “include”, “includes” and “including” are meant to be non-limiting.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Resin Composition

Applicants disclose a resin composition comprising:
a) a bismaleimide (BMI) preferably oligomerized from 4,4′-bismaleimidodiphenylmethane, bismaleimide BMI-1,3-tolyl, and o,o′-diallylbisphenol A, catalyzed with, based on total composition weight, from about 1% to about 5%, preferably about 2 percent of dicumyl peroxide or cumene hydroperoxide;
b) a bisphenol A dicyanate ester, catalyzed with from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a metal ion concentration derived from metal carboxylates or chelates such as zinc(II)naphthenate (from about 60 ppm to about 150 ppm Zn²⁺), zinc(II)acetylacetonate (about 60 ppm Zn²⁺), copper(II)acetylacetonate (from about 100 ppm to about 500 ppm Cu²⁺), copper(II)naphthenate (about 200 ppm Cu²⁺), cobalt(II)acetylacetonate (from about 170 to about 370 ppm Co²⁺), or cobalt(III)acetylacetonate (from about 120 to about 360 ppm Co³⁺), preferably said metal chelate is selected from the group consisting of copper(II)acetylacetonate, cobalt(III)acetylacetonate and mixtures thereof;
c) a bisphenol E dicyanate ester, catalyzed with from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a total of about 50 ppm to about 360 ppm of Cu²⁺ or Co³⁺ metal ion concentration derived from metal chelates, preferably said metal chelates are selected from the group consisting of copper(II)acetylacetonate, cobalt(III)acetylacetonate, and mixtures thereof;
d) a bisphenol A dicyanate ester, catalyzed with m-cresol at a concentration from about 0.75 phr to about 6 phr, and from about 50 ppm to about 360 ppm of Cu²⁺ or Co³⁺ metal ion concentration derived from metal chelates, preferably said metal chelates are selected from the group consisting of copper(II)acetylacetonate, cobalt(III)acetylacetonate, and mixtures thereof;
e) a bisphenol E dicyanate ester, catalyzed with m-cresol at a concentration from about 0.75 phr to about 6 phr, and from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof;
f) a bisphenol A dicyanate ester, a novolac cyanate ester, said bisphenol A dicyanate ester, and novolac cyanate ester, being present in a mass fraction ratio of from about 0.7:0.3 to about 1:1, from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a total of from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof;
g) a bisphenol E dicyanate ester, a novolac cyanate ester, said bisphenol E dicyanate ester, and novolac cyanate ester, being present in a mass fraction ratio of from about 0.7:0.3 to about 1:1, from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a total of from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof;
h) a bisphenol A dicyanate ester, a novolac cyanate ester, said bisphenol A dicyanate ester, and novolac cyanate ester being present in a mass fraction ratio of from about 0.7:0.3 to about 1:1, catalyzed with about 0.75 phr to about 6 phr m-cresol and from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof; or
i) a bisphenol E dicyanate ester, a novolac cyanate ester, said bisphenol E dicyanate ester, and novolac cyanate ester being present in a mass fraction ratio of from about 0.7:0.3 to about 1:1, catalyzed with about 0.75 phr to about 6 phr m-cresol and from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof.

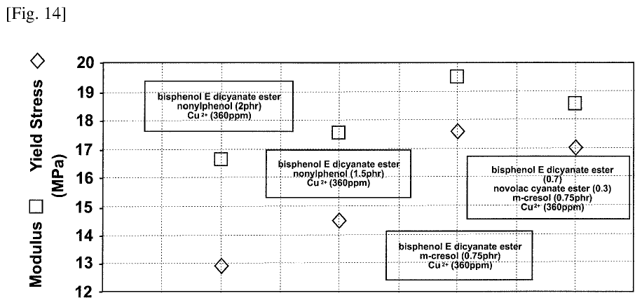

Resin systems a) through i) of Paragraph 0030 are listed in order from preferred to more preferred to most preferred with i) being most preferred. Such resin systems improve the mechanical properties of composites made therefrom under conditions of elevated temperatures and high stress. Although nonylphenol is a conventionally utilized proton donor catalyst in the catalysis of cyanate esters due to its high boiling point, molecularly, it is a nine carbon aliphatic chain that often acts as a residual plasticizer in cured polycyanate networks, reducing resin and resultant mechanical properties at elevated temperatures. The inventors discovered that when proton donor alcohols that are molecularly aromatic and smaller in size are used in substitute for nonylphenol, such as m-cresol, less could be used to solubilize a prescribed amount of metal chelate, and a lesser amount in concert with its smaller size significantly improves resin and resultant composite mechanical properties at elevated temperatures. The inventors also discovered that the elevated temperature mechanical properties of resin and resultant composites can further be improved by blending dicyanate esters (type A or E) with novolac-type cyanate esters. Novolac-type cyanate esters impart a higher cured crosslink density which increases resin softening temperature and thus mechanical properties. The higher the ratio of novolac-type cyanate ester used, the higher the resultant elevated temperature properties, at the expense of resin toughness. FIG. 14 is a graph showing the effect of cyanate ester resin composition and catalyst type on the interlaminar shear strength of carbon fiber reinforced polymer composites at a testing temperature of 200 degrees Celsius.

Bisphenol E dicyanate ester, bisphenol A dicyanate ester, and novolac cyanate ester can be obtained from Lonza, Inc., 412 Mt. Kemble Ave., Morristown, N.J. 07960, and Huntsman Advanced Materials, 10003 Woodloch Forest Drive, The Woodlands, Tex. 77380. nonylphenol, m-cresol, and suitable metal chelates can be obtained from Sigma Aldrich, 2033 Westport Center Dr., St. Louis, Mo., 63146. Bismaleimide can be obtained from Solvay Composite Materials, 4300 Jackson St., Greenville, Tex. 75401.

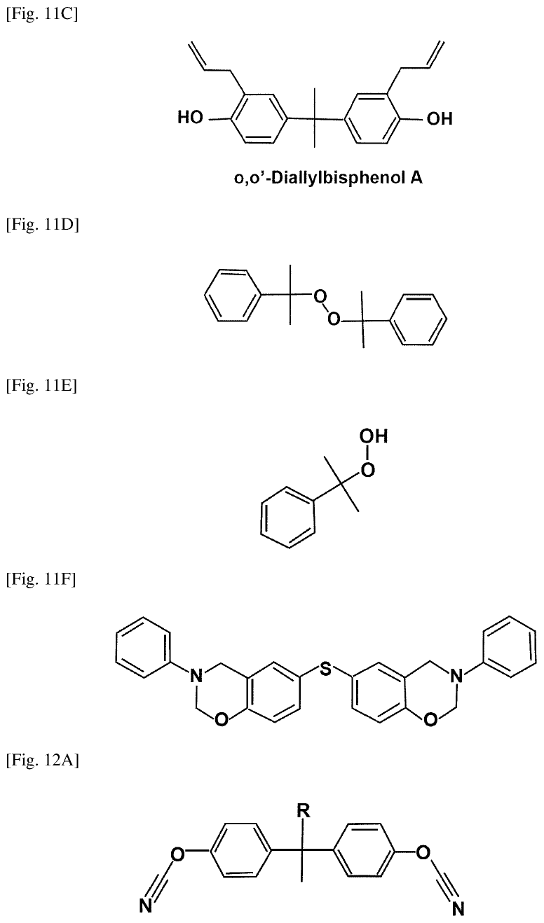

Non-limiting structures of thermosetting resin monomers and catalysts that are amenable to electromagnetic induction heating processing of fiber reinforced polymer cases include those found in FIGS. 11A through 11F.

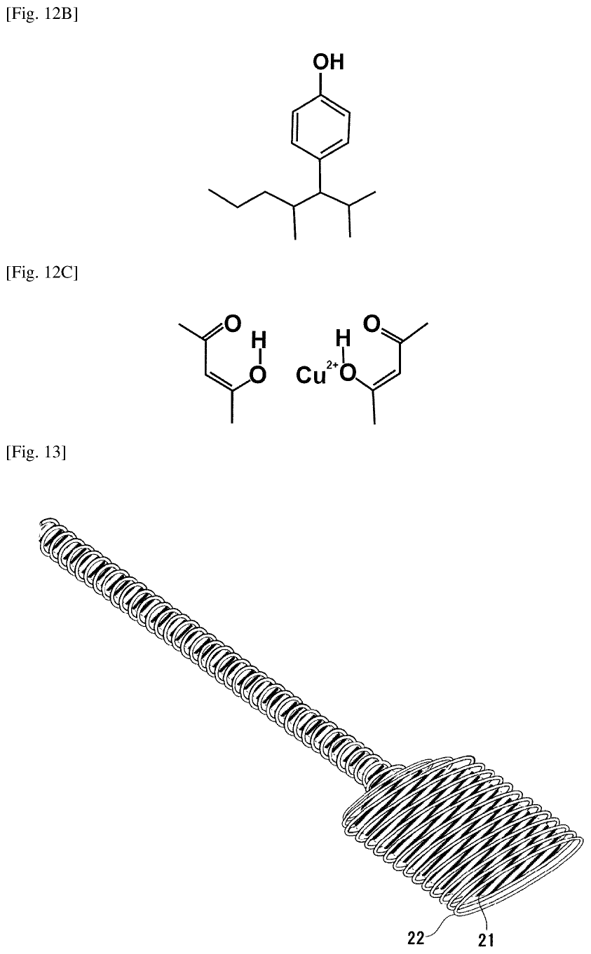

Non-limiting structures of cyanate ester resins and cure catalyst systems found to be effective for pulse electromagnetic induction cure processing include those found in FIGS. 12A through 12C.

### Fiber Reinforced Polymer Composite Structural Cases and Articles Comprising Such Cases

High performing articles include pipes; pressure vessels, including rocket motor cases and fire extinguishers; golf club shafts; tennis and badminton racquets; skis; snowboards; hockey sticks; fishing rods; bicycle frames; boat masts; oars; paddles; baseball bats; and softball bats. Rockets especially those fueled by solid propellant, often feature structural components such as cases manufactured from fiber reinforced polymer (FRP) composites. Such reinforcing fiber is designed to carry operational loads while the adhesive resin maintains fiber architecture and transfers associated stresses. A more recent advancement in the implementation of FRPs in rockets occurred in the 1990s with the application of Graphite Epoxy Motors (GEMs) in the strap-on solid boosters of Titan IV, known as the Solid Rocket Motor Upgrade (SRMU), resulting in a 25% increase in payload capability to orbit. GEMs and most other FRP composite rocket cases in production utilize resin systems, with softening (glass transition) temperatures under 200° C., with most being under 100° C. During operation, rocket components experience significant aerodynamic heating from friction with air and internal heating from the combustion of fuel and oxidizer. As such, FRP composites sometimes do not trade well with steel during the design stage of rocket components despite their higher strength-to-weight ratio, because in applications where significant thermal load is input to those components, high levels of protective insulation are required which incurs a volumetric and parasitic mass penalty.

FRP structural cases such as those used in the production solid fueled rockets are typically produced by the technique of filament winding, where continuous rovings of fibers impregnated with an adhesive polymeric resin are deposited onto an insulated sacrificial mandrel. After winding, the adhesive resin is typically cured through the use of a convection oven. The mandrel is then extracted, and the finished case product is loaded with propellant through a slurry casting process, and the nozzle and igniter are attached. This conventional manufacturing method limits the complexity of the design of the rocket, however, as it is difficult to incorporate propellant grain features beyond what can be poured into a cylinder, thrust diverting hardware, or other features that would enhance the performance of a rocket. Thus, in some instances it is advantageous to manufacture certain articles such as a rocket from the inside outwards. In the instance of a solid fueled rocket, this would entail fabrication of the solid fuel grain first and any associated propellant combustion management devices, followed by deposition of the structural case onto the propellant grain mandrel, and ultimately case cure. When filament winding is employed in the manufacture of the case, the process is termed case-on-propellant (CoP) or direct filament winding (DFW). To ensure safety and component survival during DFW, a low temperature curing resin is utilized as resin curing must be conducted in a manner which does not cause damage to the propellant, and in the worst case scenario, catalysis of an ignition event. The low temperature resin results in a low performance case requiring additional parasitic mass for fortification.

High temperature resins are typically avoided as high oven temperatures are required to cure such resins and such elevated temperatures impart excessive thermal energy to heat sensitive materials. Applicants recognized that the source of the problem was not only the amount of thermal energy provided by a curing oven but even more importantly the rate at which such thermal energy is applied. In short, Applicants recognized that the true source of the problem was the lack of thermal control afforded by typical resin curing methods.

Electromagnetic induction heating is a process where an article (workpiece), normally steel, is exposed to an oscillating magnetic field generated by an alternating current (AC) passing through a coil (inductor). The workpiece couples to the inductor and current is generated within, which is normally concentrated near the workpiece surface in proximity to the coil, and current depth can be tuned through modulation of the AC current's frequency. Due to the intrinsic resistance to the flow of electrical current within the workpiece, heat is generated, termed resistance heating. This process is normally relegated to the melting, sintering, or heat treating of steels that contain some concentration of iron atoms, as these are magnetically polarizable thus amenable to current generation through hysteresis. The process can be applied to any workpiece material that is conductive and somewhat magnetic in nature. A unique advantage of the induction process is that heat generation within a workpiece is instantaneous and can be turned off and on judiciously.

Applicants recognized that electromagnetic induction processing would be advantageous in the thermal cure of FRP articles such as rocket components, in particular those that are filament wound. Applicants recognized that Graphite (carbon) fibers are reasonably good conductors of electrical current and bear an intrinsic resistance, therefore if electrical current could be passed through such fibers then they would be expected to generate heat, which in turn could be utilized to cure an adhesive resin system. Because of the instantaneous nature of the induction heating process, in contrast to oven cure which relies on much slower transport by conduction and convection, and because the heating source could be modulated judiciously, the process facilitates precise heat transfer control to underlying components, especially those that are heat sensitive. Applicants discovered that precisely controlled thermal curing of resin systems having a broad range of curing temperatures could be achieved, without imparting excessive thermal energy to heat sensitive materials by electromagnetic induction processes. Pulse processing that can be optionally coupled with cooling steps between pulses provide additional degrees of control, and various temperatures within the workpiece can be monitored and integrated into feedback loops to the induction system's power supply through measuring devices such as infrared cameras and thermocouples.

Applicants disclose a fiber reinforced polymer composite structure, said fiber reinforced polymer composite structural case comprising:
a) at least one fiber, said fiber having an electrical resistivity of from about 1×10\hat{ }-2 ohm-cm to about 1×10\hat{ }−4 ohm-cm and forming a continuous circuit within said fiber reinforced polymer composite structure; and
b) at least one resin having a glass transition temperature of greater than 200° C., preferably from about 200° C. to about 300° C., most preferably from about 300° C. to about 400° C., said resin optionally comprising a catalyst, said catalyst increasing the rate of crosslinking in said resin;
   said fiber reinforced polymer composite structure being a filament wound or fiber placed fiber reinforced polymer composite structural case. Suitable fibers, such as carbon fibers can be obtained from Cytec Engineered Materials of Tempe Ariz. USA; Hexcel Corporation of Stamford Conn. USA; Mitsubishi Chemical America, Inc. of New York, USA; Nippon Graphite Fiber Corporation of Cypress, Calif., USA; Toho Tenax of Chiyoda, Tokyo, Japan; Toray Carbon Fibers of Chuo-ku, Japan, Toray Carbon Fibers America of Decatur, Ala., USA, and Zoltek Corporation of St. Louis, Mo. USA. Preferred resin systems are of the two general classes comprised of thermosets and thermoplastics; for thermosets the general sub-classes are epoxies, benzoxazines, bismaleimides, phthalonitriles, cyanate esters, and polyimides (in order of increasing temperature capability). Epoxies, benzoxazines, bismaleimides, cyanate esters and mixtures thereof are preferred as they are more responsive to pulse curing. The preferred resin systems are those that cure via addition or homopolymerization, exhibit relatively low viscosities prior to a curing reaction, and can be catalyzed to greatly enhance their curing reaction rate. In one aspect, the following resins and catalyst combination can be used: homopolymerizable bisphenol E type cyanate esters, catalyzed by addition of 2-6 parts nonylphenol, and 100-400 parts copper derived from copper(II) acetylacetonate, and addition reaction type bismaleimides (BMIs), catalyzed by peroxides such as dicumyl peroxide. Suitable resins can be obtained from Cytec Engineered Materials (for example bismaleimides) of Tempe Ariz. USA; Huntsman Corporation (for example epoxies, benzoxazines, cyanate esters) of Woodlands, Tex. USA; and Lonza (for example, cyanate esters) of Basel, Switzerland. Resin/Catalyst Combinations are: epoxies that can be cured using hardeners such as phenols, anhydrides, aromatic amines, cycloaliphatic amines, aliphatic amines, and thiols, in order of increasing activity, and mixtures thereof. Epoxy cure with a hardener may be catalyzed/accelerated using tertiary amines, carboxylic acids, and alcohols (especially phenols); bismaleimide that can be cured via catalyzation with peroxides and cyanate esters that can be cured by catalyzation with alcohols, especially those which have high boiling points (200-300° C.), such as m-cresol (boiling point of 203° C.), and nonylphenol (293° C.), and can be further catalyzed with organometallic compounds such as zinc (2+) acetylacetonate, zinc (2+) naphthenate, copper (2+) acetylacetonate, copper (2+) naphthenate, cobalt (2+) acetylacetonate, and cobalt (3+) acetylacetonate.

A fiber reinforced polymer composite structure according to Paragraph 0040, said fiber reinforced polymer composite structure comprising filament wound fibers, said filament wound fibers being selected from the group consisting of polar fibers, helical fibers, hoop fibers, unidirectional zero degree fibers and mixtures thereof, preferably when said fiber reinforced polymer composite structure is a pressure containment vessel, said vessel comprises hoop fibers, when axial stiffness is desired, said fiber reinforced polymer composite structure comprises polar fibers, helical fibers, unidirectional zero degree fibers and/or mixtures thereof.

A fiber reinforced polymer composite structure according to any of Paragraphs 0040 through 0041, wherein said resin is selected from the group consisting of epoxies, benzoxazines, phthalonitriles, cyanate esters, bismaleimides and polyimides, preferably said resin is selected from the group consisting of epoxies, benzoxazines, cyanate esters, bismaleimides and mixtures thereof, more preferably said resin is selected from the group consisting of benzoxazines, cyanate esters, bismaleimides and mixtures thereof, more preferably said resin is selected from the group consisting of bismaleimides, cyanate esters and mixtures thereof, most preferably said resin comprises at least one cyanate ester.

A fiber reinforced polymer composite structure according to Paragraphs 0040 through 0042, said fiber reinforced polymer composite structure being a fiber reinforced polymer composite structural case that further comprises a mandrel comprising a rocket propellant, said mandrel having at least two ends and at least two polar openings that are on opposite ends of said fiber reinforced polymer composite structural case, said at least one fiber and resin forming a casing that encases said mandrel except at said polar openings.

A fiber reinforced polymer composite structural case according to Paragraph 0043, wherein said rocket propellant is a solid propellant or a hybrid propellant or a liquid propellant.

A fiber reinforced polymer composite structural case according to Paragraphs 0043 through 0044, comprising an insulator that is positioned between said casing and said mandrel, preferably said insulator comprises rubber. In one aspect, said rubber comprises a fiber and/or particulate. In one aspect, said fiber is a Kevlar, and/or carbon fiber. In one aspect, said particulate is silica.

A fiber reinforced polymer composite structural case according to Paragraphs 0043 through 0045, comprising at least one ignitor and at least one nozzle, said at least one ignitor and said at least one nozzle being positioned opposite each other in at least one of said polar openings.

Examples of fiber reinforced polymer composite structures are provided by FIG. 10 and FIG. 13. FIG. 10 is a depiction of cross section of insulated fiber reinforced polymer rocket motor case having a fiber reinforced polymer composite case 13, internal insulation 14, solid propellant 15 (heat sensitive mandrel), and a metallic shaft 16. During electromagnetic induction processing, current generation is concentrated in the outer layer and the insulator protects the solid propellant to some extent. Further protection for the heat sensitive mandrel may be gained through electric current pulsing coupled with cooling steps between cycles. FIG. 13, depicts a fiber reinforced polymeric paddle 21 comprising a resin. The paddle is surrounded by a coil 22. The resin can be cured by energizing the coil.

### Processes of Making Fiber Reinforced Polymer Composite Structural Cases and Articles Comprising Such Cases

Articles such as high performance solid rocket motor cases comprise Fiber Reinforced Polymer (FRP) because of the FRP high strength-to-weight ratio relative to steel. Standard solid rocket motors comprising FRP cases are typically manufactured by the following method: (1) fabrication of metallic or washout mandrel; (2) deposition of internal insulation on surface of mandrel; (3) filament winding, hand layup, or tow/tape placement of FRP onto surface of insulated mandrel; (4) cure of FRP in thermal convection oven; (5) removal of mandrel (for articles other than rocket motor cases the process could generally be stopped here)(6) installation of propellant casting hardware including center perforated bore tooling, typically featuring a star-shaped pattern to control surface area during the initial phase of the combustion cycle for the sake of adjusting the motor's thrust profile; (7) casting of propellant slurry into case; (8) cure of propellant in thermal convection oven, typically at 60 degrees Celsius; (9) extraction of propellant bore tooling; (10) installation of nozzle and igniter.

An alternative method to making articles such as high performance solid rocket motor cases that comprise Fiber Reinforced Polymer (FRP) is to fabricate the solid fuel grain first and any associated propellant combustion management devices, followed by deposition of the structural case material (fiber and resin) onto the propellant grain mandrel, and then cure such resin. To ensure safety and component survival during resin curing, a low temperature curing resin is utilized as resin curing must be conducted in a manner which does not cause damage to the propellant, and in the worst case scenario, catalysis of an ignition event. The low temperature resin results in a low performance case requiring additional parasitic mass for fortification and protection.

In the present specification, Applicants disclose an improved process of making FRP composite structural cases and articles comprising such cases wherein an electromagnetic induction heating system which drives alternating (AC) electric current through a hollow metallic conducting coil at a frequency in the kHz regime is employed. The conducting coil may be fabricated from hollow copper tubing. Water may be flowed through the copper coil while it is energized to remove any heat that is generated from the intrinsic electrical resistivity of the copper. The coil can take the form of different architectures, including solenoid, pancake, and variants where they are conformed to the surface curvature of cylindrical or domed shaped CFRP as typical of rocket motor cases. With a solenoid type coil, the motor case is situated within the inner diameter of the coil, whereas in a pancake configuration, the coil is wound in a planar configuration and would be situated near the surface of the CFRP. The magnetic fields generated by both types of coils are different. The magnetic field generated by a pancake coil is situated in the vicinity of the coil, exponentially decaying in intensity away from the coil surface. In solenoid coils, on the other hand, the magnetic field is generated in a much larger area within the coil, as well as outside to a lesser degree. The magnetic field strength may be tuned by the number of turns in a solenoid coil. The greater number of turns, the higher the resultant field strength. Coils may be shaped by filling them with a medium such as sand to prevent crimping of the internal channel during winding. CFRP is deposited onto a mandrel which does not couple (generate heat) to the magnetic field. Non-coupling mandrels can be fabricated from aluminum, rubber, glass reinforced composite, solid rocket propellant, etc. The CFRP is deposited onto the cylindrical mandrel by the processes of filament winding, hand layup, and/or tow/tape placement. Once the CFRP is fully deposited onto the mandrel, the induction coil configuration of interest is situated near the CFRP structure. This can be accomplished by a number of ways. In one method, a solenoid coil is situated around the cylindrical portion of the motor case, and the solenoid can be conformed through tapering to be in close proximity to the dome regions of the case. In another method, a bank of pancake coils can be situated near the surface of the CFRP. If complete CFRP coverage cannot be achieved due to the size of the CFRP structure to be processed or because of power limitations with the induction heating system, then the coil and induction work head can be installed onto the filament winding machine, tow/tape placement machine, or lathe, and a coil of small dimensions relative to the CFRP structure can be translated back and forth over the CFRP to promote heating. This technique has been shown to be able to provide a consistent temperature across high length/diameter cylindrical CFRP and is highly useful when power limitations with an induction heating system are faced, at the expense of heating time to a prescribed temperature. Specifically, in one example, a solenoid coil of three turns rendering a length of 3 inches, with an inner diameter of 6 inches was utilized by this method to process a cylindrical CFRP section that was 30 inches in length and 5.75 inches in inner diameter, with a thickness of 0.060 inches (6 hoop layers). Following a slow temperature ramp to 149 degrees Celsius, that temperature was consistently maintained for 12 hours by translating the coil back and forth over the CFRP. The electrical current can be applied to the coil in a programmed manner to achieve a complex curing cycle for the adhesive resin in the CFRP. Temperature ramps and dwells can be achieved if the carbon fiber response as a function of power input is well characterized. An infrared camera is used to monitor the CFRP surface temperature during the process for the sake of tuning and quality control. In the process of case-on-propellant manufacturing, pulse curing has been found effective to control heat transfer to the internal insulation interface with the solid propellant grain. For example, if the desired CFRP cure temperature is 250 degrees Celsius and the surface of the solid propellant grain cannot exceed 60 degrees Celsius, a pulse can be instituted such that the CFRP reaches 250 degrees Celsius rapidly, and is maintained until the solid propellant interface reaches 60 degrees Celsius, as measured by an embedded thermocouple situated at that interface (use of a metallic thermocouple that does not couple to a magnetic field such as Type E is preferred). At that time, the pulse is turned off, and to efficiently transfer the heat away from the solid propellant interface, a convective cooling gas can be flowed over the CFRP. The cooling gas can be generated from the evaporation of liquid nitrogen for a cold temperature source, or could be compressed air or inert gas. Once the solid propellant interface temperature drops back down to a lower temperature, the next pulse can be instituted. This process can be repeated for any number of cycles until the desired total CFRP cure time is achieved and can be controlled through programmed communication feedback loops between thermocouples, an IR camera, the induction heating system, and the cooling system. In the event the case mandrel is not sensitive to temperature, a constant temperature can be maintained in the CFRP until full cure is achieved. The CFRP resin system can be tailored to cure quickly through the aid of catalysts, or selected to respond favorably to pulse type curing. The efficiency of the carbon fiber to generate heat is a function of induction heater power, current frequency, and layup architecture. Increasing power and frequency (especially the latter), augments carbon fiber response. A coil will self-tune to a specific frequency so this is typically not a readily adjustable variable but is rather coil architecture dependent. It has been observed that CFRP configured in a 90 degree orientation relative to the mandrel axis are most efficient in generating heat in the presence of a traditional solenoid coil (coil is oriented in same direction as fiber windings), but heat is also generated in layups of lesser angles.

An induction heating system that can generate suitable coil frequencies typically uses a resonant circuit including a generator (power supply), capacitor, and inductor, which may be parallel or in series. A radio-frequency (RF) power supply may be used to generate the desired frequency ranges. Suitable types of RF power supplies include vacuum tube and solid-state. The former provides frequencies ranging from 200-450 kHz while the latter ranges from 50-450 kHz. Solid-state power supplies are particularly suitable because they typically provide the greatest frequency range. Such power supply may be powered by Metal Oxide Semiconductor Field Effect Transistor (MOSFET) output devices.

Suitable commercial induction heating systems include Ambrell Corporation of Rochester N.Y. USA's lines of EASYHEAT (1-10 kW) and EKOHEAT (10 kW-500 kW) systems, UltraFlex Power Technologies of Ronkonkoma N.Y. USA's power supplies and induction heating systems, and CEIA USA Ltd. Of Twinsburg, Ohio USA's generators and heating heads.

Applicants disclose a process of making a fiber reinforced polymer composite structure, said fiber reinforced polymer composite structure comprising a mandrel, preferably said mandrel comprises a material selected from the group consisting of aluminum, rubber, a glass reinforced composite, a rocket propellant and mixtures thereof, wrapped via a filament winding process and/or a fiber placement process with at least one resin and at least one fiber to form a continuous circuit from said fiber, said fiber having an electrical resistivity of from about 1×10\hat{ }−2 ohm-cm to about 1×10\hat{ }−4 ohm-cm; said process comprising the step of curing said resin by applying, in a continuous or pulsed manner, a magnetic field that is generated by alternating current in the kHz regime to said fiber reinforced polymer composite structure until said at least one resin is cured, preferably said kHz regime is at least 50 kHz, more preferably said kHz regime from about 50 kHz to about 450 kHz. Optionally, said fiber reinforced polymer composite structure is cooled between pulses by passing a cooling fluid over said fiber reinforced polymer composite structure, preferably said cooling fluid is a gas, more preferably said gas is inert, most preferably said gas comprises nitrogen. A suitable fluid specification for the cooling of an induction coil will typically have a minimum pressure differential of 30 psi, a maximum inlet temperature of 95° F., a pH between 7.0 and 9.0, chloride content less than 20 ppm, nitrate content less than 10 ppm, sulfate content less than 100 ppm, calcium carbonate content less than 250 ppm, total dissolved solids content less than 250 ppm, no solids to precipitate at temperatures less than 135° F., resistivity greater than 2500-ohm-cm at 77° F., contain a magnetite eliminator and corrosion inhibitor, and a maximum concentration of antifreeze of 50%, in the form of uninhibited ethylene glycol. Preferably said cooling fluid is ion free or essentially ion free. The required cooling fluid flow rate through the coil is determined from calculation of I²R where I is electrical current and R is coil resistivity, and the allowable temperature of the coil itself.

Applicants disclose a process according to Paragraph 0053, wherein said magnetic field is generated by running said alternating current in the kHz regime through a coil, said coil comprising an internal passage through which a cooling fluid can be passed, preferably said coil has a conductivity of at least 4.5×10\hat{ }7 S/m, more preferably from about 4.5×10\hat{ }7 S/m to about 5.8×10\hat{ }7 S/m, most preferably from about 5.8×10\hat{ }7 S/m to about 6×10\hat{ }7 S/m, as measured by ASTM E1004 (Standard Test Method for Determining Electrical Conductivity Using the Electromagnetic (Eddy Current) Method), at 20° C., preferably said coil comprises copper, silver, or gold, and mixtures thereof.

Applicants disclose a process according to Paragraph 0053 through 0054, wherein said process employs at least one coil selected from the group consisting of a solenoid coil, an axial coil, a helical coil and a multi-axial coil. Typically, when said coil is a solenoid coil, said solenoid coil is aligned perpendicular to the long axis of said fiber reinforced polymer composite structure, when said coil is a axial coil, said axial coil is aligned parallel to the long axis of said fiber reinforced polymer composite structure, when said coil is a helical coil, said helical coil is oriented/aligned at an angle from 0 degrees to 90 degrees to the long axis of said fiber reinforced polymer composite structure and when said coil is a multi-axial coil, said multi-axial coil is oriented/aligned at an angle from 0 degrees to 90 degrees to the long axis of said fiber reinforced polymer composite structure.

Applicants disclose a process according to Paragraphs 0053 through 0055, wherein said coil is translated over the surface of said fiber reinforced polymer composite structure. As a coil's power increases, its ability to accommodate higher alternating current frequencies diminishes. By translating said coil, the tradeoff between coil power and the frequency that the coil can accommodate is greatly reduced. As a result, by translating said coil, larger fiber reinforced polymer composite structures can be cured with smaller magnetic induction systems.

Applicants disclose a process according to Paragraphs 0053 through 0056, said filament wound fibers are selected from the group consisting of polar fibers, helical fibers, hoop fibers, unidirectional zero degree fibers, braided sleeves, and mixtures thereof, preferably when said fiber reinforced polymer composite structure is a pressure containment vessel, said fiber reinforced polymer composite structure comprises hoop fibers, when axial stiffness is desired, said fiber reinforced polymer composite structure comprises polar fibers, helical fibers, unidirectional zero degree fibers, braided sleeves, and/or mixtures thereof.

Applicants disclose a process according to Paragraphs 0053 through 0057 wherein and said at least one resin has a glass transition temperature of greater than 80° C., preferably greater than 200° C., more preferably from about 250° C. to about 400° C., most preferably from about 300° C. to about 400° C.

Applicants disclose a process of making an fiber reinforced polymer composite structural case according to Paragraphs 0053 through 0058, wherein
a) said resin is cured by a continuous magnetic field and said resin is selected from the group consisting of epoxies, benzoxazines, phthalonitriles, cyanate esters, bismaleimides and polyimides, preferably said resin is selected from the group consisting of epoxies, benzoxazines, cyanate esters, bismaleimides and mixtures thereof, more preferably said resin is selected from the group consisting of benzoxazines, cyanate esters, bismaleimides and mixtures thereof, more preferably said resin is selected from the group consisting of bismaleimides, cyanate esters and mixtures thereof, most preferably said resin comprises at least one cyanate ester; or
b) said resin is cured by a continuous magnetic field and said resin is selected from the group consisting of epoxies, benzoxazines, bismaleimides, cyanate esters and mixtures thereof, preferably said resin is selected from the group consisting of benzoxazines, bismaleimides, cyanate esters and mixtures thereof; more preferably said resin is selected from the group consisting of bismaleimides, cyanate esters and mixtures thereof; most preferably said resin comprises at least one cyanate ester.

Applicants disclose a process of making a fiber reinforced polymer composite structural case, according to Paragraphs 0053 through 0059, wherein said fiber reinforced polymer composite structural case further comprises a mandrel comprising a rocket propellant, said mandrel having at least two ends and at least two polar openings that are on opposite ends of said fiber reinforced polymer composite structural case, said at least one fiber and resin forming a casing that encases said mandrel except at said polar openings, preferably said rocket propellant's surface temperature is kept from reaching 60° C. The prevailing notion is that the solid propellant grain should not be exposed to temperatures exceeding 60° C. during manufacture, for fear of accelerated aging which could reduce grain mechanical properties, alter burn rates, catalyze migration of plasticizers free to move in the propellant to grain boundaries thus impacting interface adhesion or other key properties, and precipitate separations between the case and grain which could lead to motor failure during operation. In a worst case scenario, elevated temperature exposure could cause the propellant to ignite.

Applicants disclose a process of making a fiber reinforced polymer composite structural case, according to Paragraph 0060, wherein said rocket propellant is a solid propellant or a hybrid propellant or a liquid propellant.

Applicants disclose a process of making a fiber reinforced polymer composite structural case, according to Paragraphs 0060 through 0061, wherein said fiber reinforced polymer composite structural case comprises an insulator that is positioned between said casing and said mandrel, preferably said insulator comprises rubber. In one aspect, said rubber comprises a fiber and/or particulate. In one aspect, said fiber is a Kevlar, and/or carbon fiber. In one aspect, said particulate is silica.

Applicants disclose a process of making an fiber reinforced polymer composite structural case, according to Paragraphs 0060 through 0062, wherein said fiber reinforced polymer composite structural case comprises an least one ignitor and at least one nozzle, said an least one ignitor and said at least one nozzle being positioned opposite each other in at least one of said polar openings.

Applicants disclose a process of making a fiber reinforced polymer composite structural case, according to Paragraphs 0053 through 0063, said process comprising pulse curing of said at least one resin.

Applicants disclose a process of making a fiber reinforced polymer composite structural case, according to Paragraphs 0053 through 0064, wherein said fiber reinforced polymer composite structural case is actively or passively cooled between said pulses.

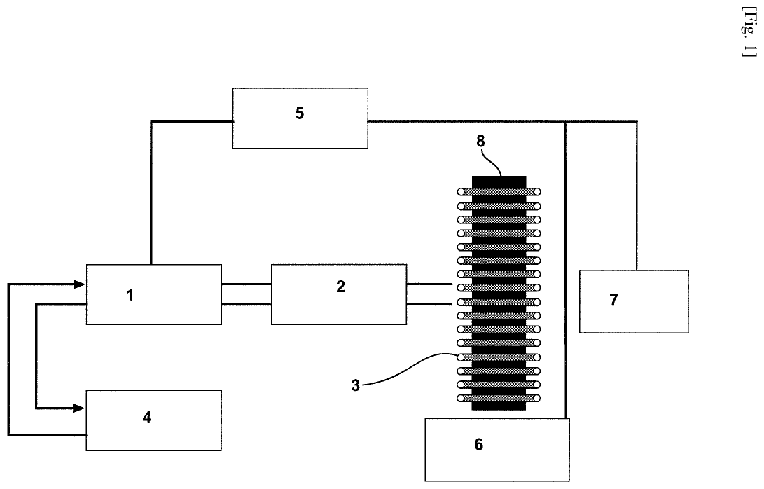

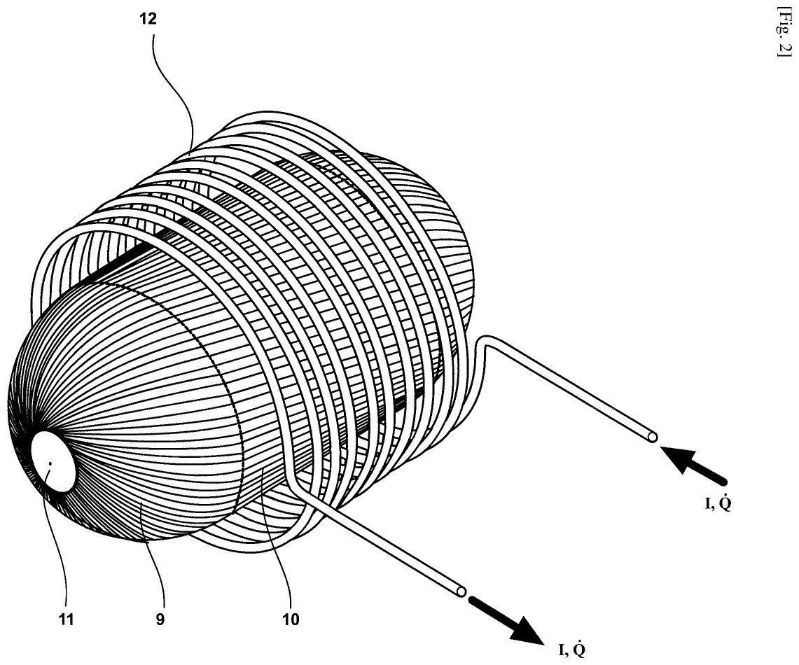

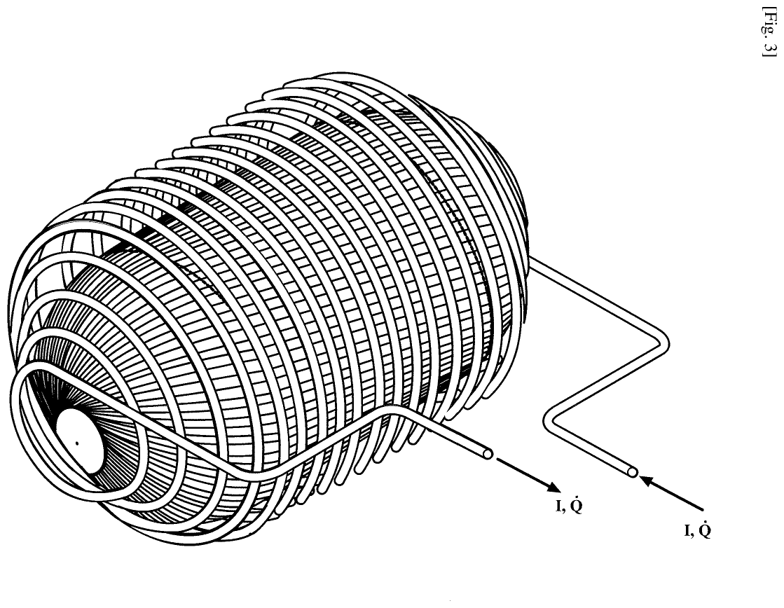

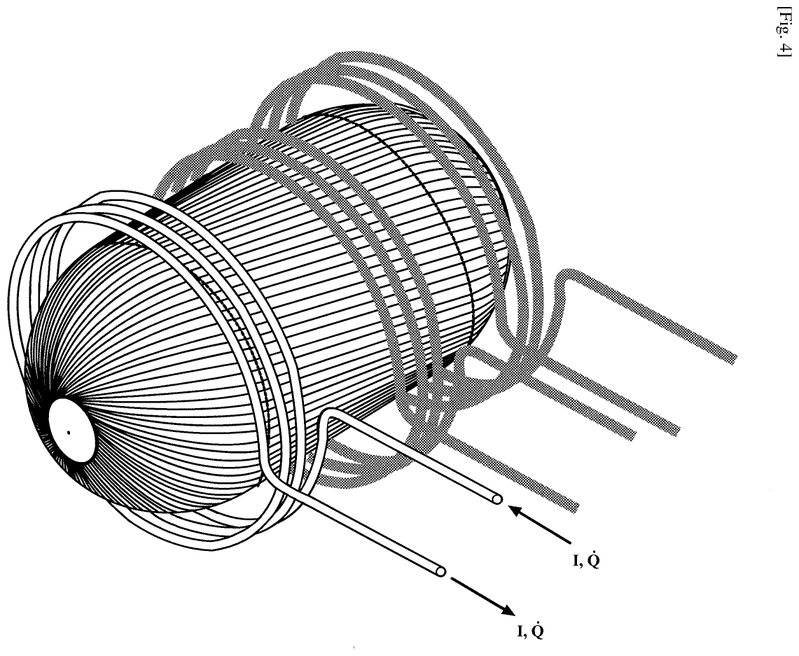

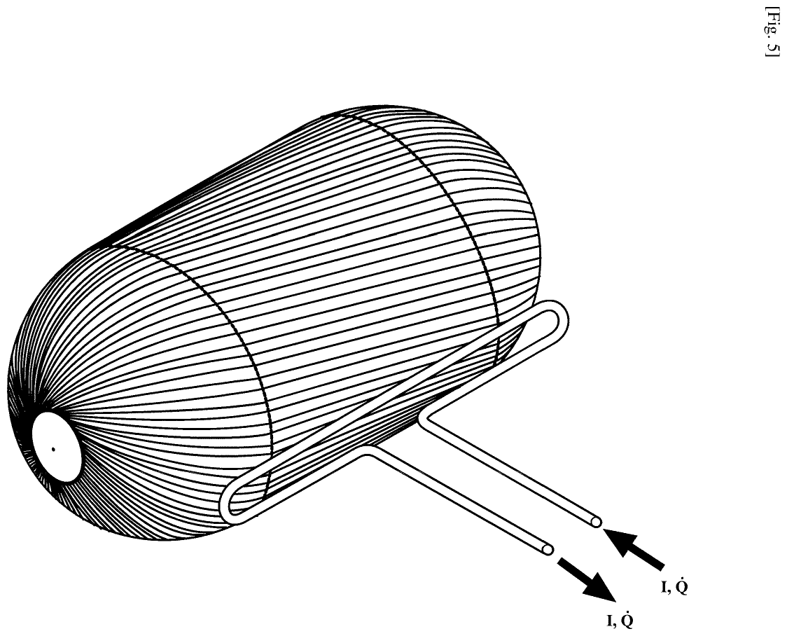

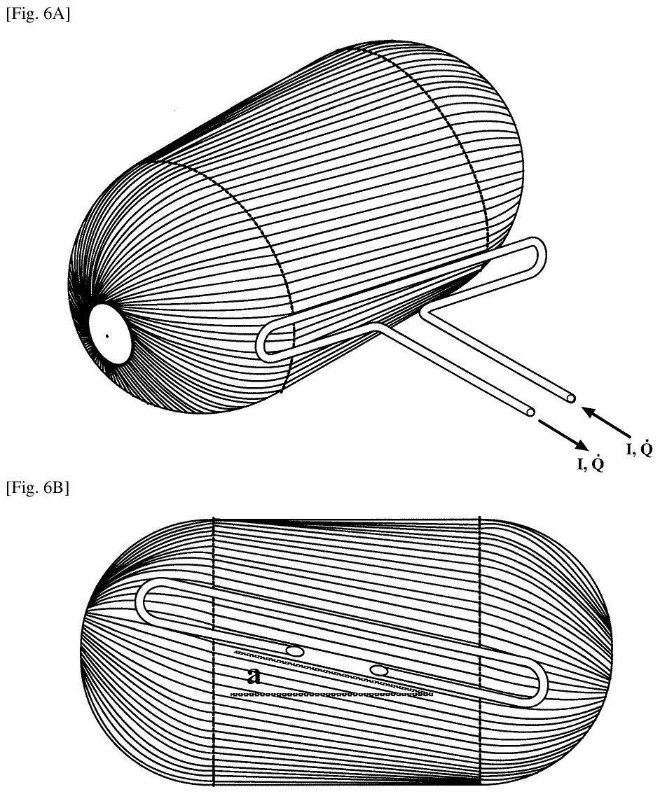

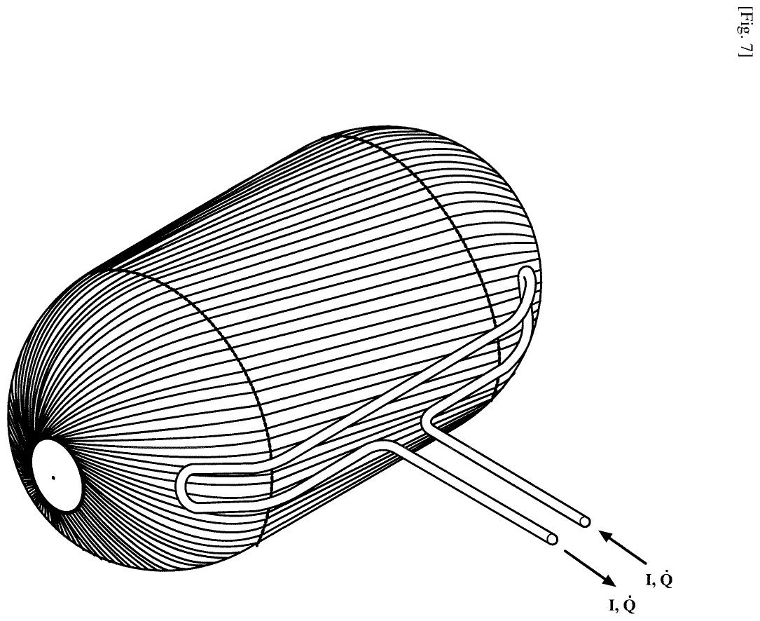

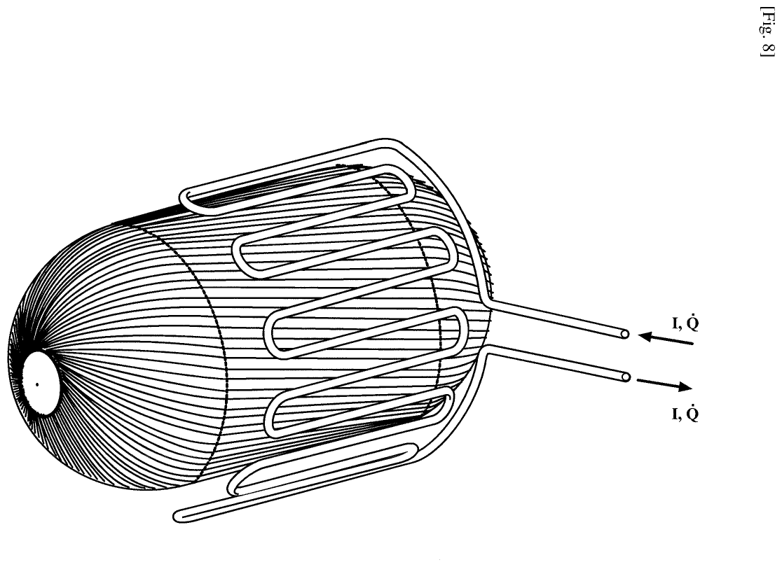

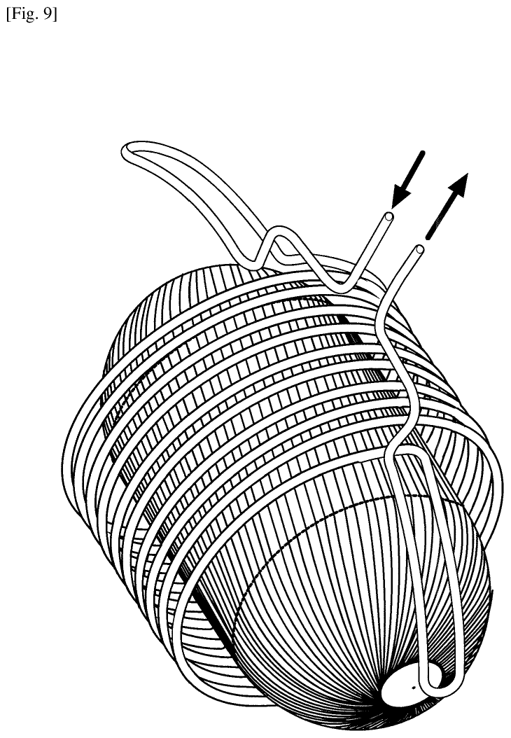

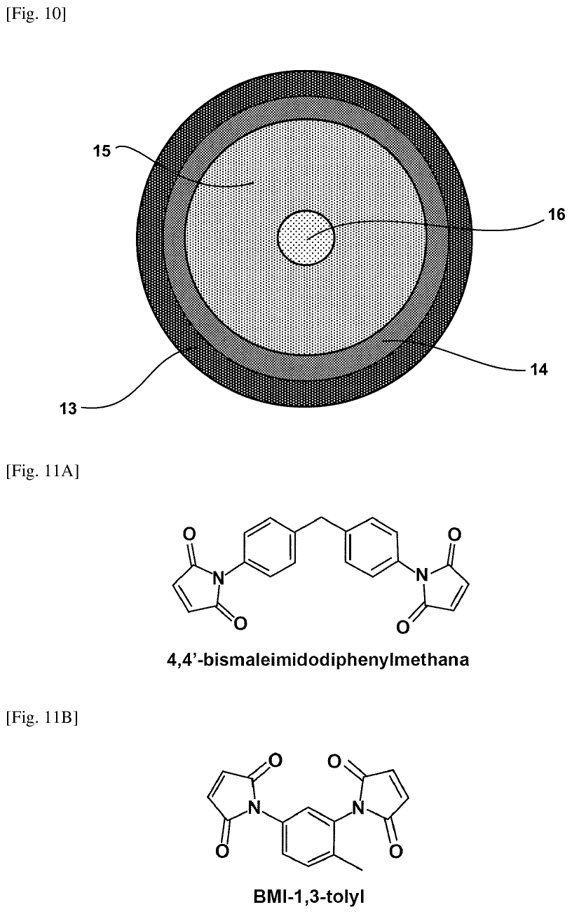

Additional processing detail is provided by FIG. 1 through FIG. 9. FIG. 1 is a schematic of basic components of an induction heating system comprising: power supply (Inverter) 1, tank circuit (Workhead) 2, coil 3, water cooling system 4, temperature controller 5, thermocouples 6, infrared camera 7 and workpiece 8. FIG. 2 is a schematic of the principles of magnetic induction heating of a fiber reinforced polymer composite case having a fiber reinforced polymer composite polar or helical layer that forms the domes 9 and runs in parallel to the axis of the case, and a fiber reinforced polymer composite hoop layer that is oriented perpendicular to the axis of the case. With the depicted coil configuration, current is principally generated in this layer, mandrel substrate which may be comprised of a heat sensitive material. Solenoid coil 12 through which an alternating current I and cooling fluid of a flow rate Q^{dot} passes generates a magnetic field whose strength is dictated by current amperage and number of coil turns, which in turn generates eddy currents within the hoop layer. The electrical resistivity of the fiber causes heat to be generated which can be used to cure the polymer adhesive resin. FIG. 3 is a schematic of a continuous solenoid coil that is conformed to the dome regions of the fiber reinforced polymer composite case such that the spacing between the coil and the case is constant. Here, eddy currents are generated within the workpiece in the opposite direction of the current flow through the coil; the resistivity of the fiber is lower in the hoop layer because it is aligned with current generation and therefore flow is less impeded. In the dome section, the electrical resistivity is higher because the current must jump fibers, therefore heat generation is not as effective in these regions. FIG. 4 is a depiction of a 3 turn solenoid coil in linear translation movement over the cylindrical region of a fiber reinforced polymer composite case. Using this technique, long sections of a case can be heated using a short coil which is effective when electromagnetic induction equipment is limited in its power capacity. The translation technique facilitates the heating of articles much larger in size than a coil, at the cost of workpiece time to target temperature. FIG. 5 is a depiction of single lobe axial coil positioned over a fiber reinforced case. In this configuration, a magnetic field is generated in close proximity to the coil and electrical current is generated most efficiently in the polar or helical layers of the case. Current flows through the fiber if it is continuous, therefore heat generation also occurs on the opposite side of the case where there is no coil. This technique affords uniform heat generation in the dome sections if the case is rotated during coil energization. FIGS. 6A and 6B depict a single lobe axial coil positioned over a fiber reinforced polymer case, tilted at an angle α that is parallel with direction of the fiber tows in the helical and/or polar layers. Manipulation of coil angle can affect the rate and magnitude of heat generation in the fibers. FIG. 7 is a depiction of single lobe axial coil positioned over a fiber reinforced polymer case, with ends shape conformed to the surfaces of the dome section contours. This coil can provide a higher rate and magnitude of heat generation in the dome sections of the case. FIG. 8 is a depiction of multi-lobe axial coil positioned over the cylindrical region of a fiber reinforced polymer case. Due to its greater coverage over the case, the rate and magnitude of heat generation can be enhanced. Uniform heat generation throughout the entire case can be achieved, whose rate and magnitude is proportional to the number of coil lobes. During heat generation, the case can be rotated to promote temperature uniformity. Finally, FIG. 9 is a depiction of a hybrid coil featuring both solenoid and axial elements in series.

### Examples

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1. A solid rocket motor case mandrel assembly, used as a substrate to manufacture a fiber reinforced polymeric structural case, consisting of any number of discrete solid propellant grains, is situated onto a cylindrical metallic shaft. The forward and aft ends of the propellant grain sub-assembly are capped with metallic polar fittings (bosses) that facilitate the installation of an igniter and nozzle once the structural case of the solid rocket is manufactured. The discrete propellant grains may have been cast and cured into pre-molded rubber-based internal insulation, or the insulation may be deposited onto the pre-cured propellant grain assembly after their positioning onto the shaft. Any components associated with divert attitude control systems may also be incorporated into the propellant grain sub-assembly. Once the case mandrel is completely assembled, it is inserted into the vice chucks of a filament winding machine. Carbon fiber tows that are pre-impregnated with cyanate ester resin and a cure reaction rate enhancing catalyst are then filament wound onto the mandrel in any programmed sequence of polar, helical, and hoop layers. Hand layup of unidirectional 0 degree layers and/or braided sleeves may also be instituted. Once the filament winding process is complete, a coil comprised of hollow coper tubing, formed to a classical solenoid configuration, is situated over the filament wound rocket motor case (the workpiece) in close proximity to its surface (within 5 mm). The coil is connected to an induction heating machine comprised of a work head and power supply. The induction heating machine is programmed for a specific amperage/time cycle based on predetermined parameters known to not cause excessive heat transfer to the propellant grain. Alternatively, thermocouples are positioned at strategic locations at the propellant grain/internal insulation interface, with leads emanating from the mandrel assembly, which are connected to the induction heating machine's control software, facilitating a feedback loop for pulse power control. The induction coil is energized with alternating electrical current at the natural frequency of the coil and work head circuit, and for effective processing, the frequency should be above 50 kHz. The induction coil while energized creates a magnetic field of a strength determined by the current amperage, coil diameter, and number of coil turns. This magnetic field in turn generates an electrical current through any conductor within the workpiece, with the strongest generated current in close proximity to the coil. Therefore the strongest current is generated within the conductive carbon fiber. Because of the intrinsic electrical resistivity of the fiber, heat is generated as the current flows most effectively through the continuous carbon fiber. Due to the orientation of the solenoid coil, current is most effectively generated in the hoop layers (those oriented perpendicular to the shaft axis), and as such, those layers generate the most heat. Heat generated within the carbon fiber is transferred to the cyanate ester resin, precipitating its curing reaction. The cyanate ester is optimally cured at 150 degrees Celsius for one hour, followed by at least one hour at 220 degrees Celsius. However, the propellant grain-internal insulation interface should not be allowed to exceed 60 degrees Celsius for significant time. At the point that this interface temperature reaches 60 degrees Celsius, the electromagnetic pulse is terminated. The carbon fiber reinforced polymer (CFRP) structure is then allowed to cool either passively or actively. In active cooling, a stream of gaseous nitrogen is passed over the CFRP surface, and when the interface cools down to 30 degrees Celsius, the next electromagnetic pulse is initiated. The magnitude of the depth of pulse cooling drives the length of the next heating pulse. Electromagnetic pulse heating and cooling cycles are implemented until target extent of cure of the CFRP resin is achieved.

Example 2. A process according to Example 1 is implemented, however in this Example 2, the coil is configured to have axial lobes that are parallel to the axis of the filament wound CFRP laminate. This type of coil will more so generate heat in the polar and helical layers, which form the domes. Further, a coil can be configured and implemented having both solenoid and axial elements.

Example 3. A process according to Example 1 is implemented, however in this Example 3, a thermoplastic resin such as poly(ether-ether-ketone) is used as the CFRP adhesive resin. A shrink tape or film or other pressure intensifying medium such as silicone rubber is situated over the CFRP laminate. During induction heating processing of the CFRP, heat generation that is transferred to the pressure intensifying media enables a compaction force to the CFRP laminate which consolidates the thermoplastic matrix.

Example 4. In another example, the filament winding mandrel is comprised of a metal. This mandrel is monolithic in structure. Ideally, the comprising metal is chosen to weakly couple to the magnetic field generated by the induction coil (for example, aluminum is a good candidate) such that the adhesive resin used in the filament winding process does not degrade due to excessive thermal exposure during processing. After the filament wound composite is deposited onto the mandrel and cured, the mandrel may be left in or it may be extracted. This process could be used in the manufacture of composite pipes, rods, poles, blades, etc.

Example 5. In this example, the process illustrated in Example 4 is implemented, however, instead of processing discrete objects by batch methods, the process is utilized in a continuous manner. Long, continuous sections of filament wound composite are processed in a discrete section of induction coil to cure the composite resin. After passing through the induction coil element, the processed continuous article may be cut into discrete sections for the mass production of a specific part at a higher rate.

Example 6. In this example, the process described in Example 4 is implemented, however in this application the mandrel is metallic and puzzle type, or comprised of plaster, or comprised of a water soluble tooling material (e.g. particulates bound by sodium silicate, polyvinyl alcohol, or polyvinylpyrrilidone, or a mandrel comprised of a water soluble salt). After induction cure of the filament wound composite on this type of mandrel, the mandrel is extracted. In the case of a metallic puzzle mandrel, it is disassembled through polar openings and extracted piece by piece. In the case of plaster, it is broken and the resultant pieces are extracted. In the case of water soluble tooling, the mandrel is washed out. Through use of this type of mandrel, more complex shapes may be manufactured, such as turbine blades and crankshafts.

Example 7 Boat Mast: A preform having the desired inner geometry is made. Then, flat panels of defined dimensions are cut from carbon fiber unidirectional mat prepreg on a two dimensional routing table. The flat panels are laid up by hand onto the preform. After a prepreg layer is installed, plastic tape is deposited under tension onto the prepreg surface to compress, debulk, and remove creases. Prior to deposition of the next prepreg layer, the plastic tape is removed, unless it is the last layer, which is left on. After all prepreg is installed onto the preform, breather cloth is placed onto the surface of the plastic film. Typically, to cure the prepreg resin, the entire boat mast assembly is processed under vacuum and pressure in an autoclave. However, the magnetic induction cure process is implemented to eliminate such timely and costly step. To do so, once breather cloth is installed, the assembly is bagged in the same manner as would be done if autoclave processing, but a pressure intensifying medium silicone rubber sheeting is installed onto the breather cloth's surface, followed by winding of glass fiber under high tension onto the surface of the silicone. The part assembly could then be situated in a magnetic induction coil and the resin cured.

Example 8 Piping/Tubing: Carbon fiber composite tubing and piping is made by first cutting prescribed patterns of unidirectional and/or woven prepreg with a Computer Numerical Controlled (CNC) machine. Those flat patterns are roll wrapped into tubes onto a mandrel. Once all prepreg layers are deposited, the outer surface of the prepreg is wrapped with a plastic layer of film under tension or compression tape which acts to compact the composite material during resin cure. The piping/tubing assembly is inserted into a magnetic induction coil and cured in a precise manner more quickly, than an oven to curing process thus improving unit throughput rate. After cure, the tape is removed and the mandrel is extracted to produce the finished parted.

Example 9 Automotive Drive Shafts: Carbon fiber composite automotive drive shafts are made by first, mixing an adhesive resin for the carbon fiber filaments with particulate additives that provide another level of reinforcement. Continuous tows of carbon fibers are then drawn through a bath containing the resin mixture and deposited onto a mandrel having the prescribed inner dimensions of the shaft at prescribed angles by the process of wet filament winding. Once the winding is complete, compaction tape is deposited under tension to the composite surface to provide a compaction force during resin cure. The drive shaft assembly is cured in a more precise manner and more quickly, than can be achieved by oven curing, by situating a magnetic induction coil around the assembly while still on the filament winding machine, and the part is rotated by the winding machine chucks during resin cure. This processing step eliminates the need for an oven. Once the adhesive resin is cured, the compaction tape is removed, the mandrel is extracted, and metal ends are bonded to the ends of the drive shaft that will act as durable interfaces when installed into a vehicle.

Example 10 Adhesive Resin and Fiber Impregnation: a preferred resin system consisting of bisphenol E dicyanate ester and a novolac type cyanate ester resin, catalyzed by a combination of nonylphenol and a metal chelate such as copper(II)acetylacetonate, which is 70/30 bisphenol E dicyanate ester/novolac cyanate ester, and 2 phr nonylphenol and 360 ppm Cu²⁺, is prepared as follows: 700 grams of liquid bisphenol E dicyanate ester is added to a glass vessel. Then, 300 grams of liquid novolac type cyanate ester is added to the same vessel. The two cyanate ester components are heated to 80° C., using a hot plate, immersion bath, or jacketed vessel, and stirred until the mixture is homogenous and phases cannot be distinguished. Mixing is conducted either by a large magnetic stir bar or overhead mechanical agitator. Homogenization typically takes up to three hours, and once completed, the mixture is cooled to room temperature. In a separate glass vessel, most preferably a scintillation vial, 30 grams of liquid nonylphenol is added. Also added is 0.022 grams of copper(II) acetylacetonate, in the form of a blue powder. A magnetic stir bar is immersed into the liquid in the vial. The vial is then situated on a hot plate and the mixture is heated to 60-100° C. The mixture is then stirred until homogenization is completed, as evidenced by disappearance of any particulate copper(II)acetylacetonate. This process typically takes up to 12 hours, and process time decreases with increasing temperature. Once this step is complete, the catalyst mixture is allowed to cool. Lastly, 20.015 grams of the catalyst mixture is added to the cyanate ester mixture, at room temperature, and stirred in either by hand or mechanically. The resultant cyanate ester blend with catalyst is then used in the manufacture of carbon fiber reinforced polymer towpreg. Resin impregnation into carbon fiber tows is performed using a suitable continuous impregnation machine, consisting at minimum, a resin reservoir, a resin deposition system, an impregnation die, and a fiber takeup (re-spooling system), with a fiber tensioning device. Resin is continuously deposited onto continuous carbon fiber tows and drawn through the impregnation die, followed by resultant towpreg re-spooling.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

1. A fiber reinforced polymer composite structure, said fiber reinforced polymer composite structure comprising:
a) at least one fiber, said fiber having an electrical resistivity of from about 1×10\hat{ }-2 ohm-cm to about 1×10\hat{ }-4 ohm-cm and forming a continuous circuit within said fiber reinforced polymer composite structure; and
b) at least one resin having a glass transition temperature of greater than 200° C., preferably from about 200° C. to about 300° C., most preferably from about 300° C. to about 400° C., said resin optionally comprising a catalyst, said catalyst increasing the rate of crosslinking in said resin;
said fiber reinforced polymer composite structure being a filament wound or fiber placed fiber reinforced polymer composite structure.

2. A fiber reinforced polymer composite structure according to claim 1, said fiber reinforced polymer composite structure comprising filament wound fibers, said filament wound fibers being selected from the group consisting of polar fibers, helical fibers, hoop fibers, unidirectional zero degree fibers and mixtures thereof, preferably when said fiber reinforced polymer composite structure is a pressure containment vessel, said vessel comprises hoop fibers, when axial stiffness is desired, said fiber reinforced polymer composite structure comprises polar fibers, helical fibers, unidirectional zero degree fibers and/or mixtures thereof.

3. A fiber reinforced polymer composite structure according to any of claim 1 or 2, wherein said resin is selected from the group consisting of epoxies, benzoxazines, phthalonitriles, cyanate esters, bismaleimides and polyimides, preferably said resin is selected from the group consisting of epoxies, benzoxazines, cyanate esters, bismaleimides and mixtures thereof, more preferably said resin is selected from the group consisting of benzoxazines, cyanate esters, bismaleimides and mixtures thereof, more preferably said resin is selected from the group consisting of bismaleimides, cyanate esters and mixtures thereof, most preferably said resin comprises at least one cyanate ester.

4. A fiber reinforced polymer composite structure according to any preceding claim, said fiber reinforced polymer composite structure further comprising a mandrel comprising a rocket propellant, said mandrel having at least two ends and at least two polar openings that are on opposite ends of said fiber reinforced polymer composite structure, said at least one fiber and resin forming a casing that encases said mandrel except at said polar openings.

5. A fiber reinforced polymer composite structure according to claim 4, wherein said rocket propellant is a solid propellant or a hybrid propellant or a liquid propellant.

6. A fiber reinforced polymer composite structure according to any of claims 4 to 5, comprising an insulator that is positioned between said casing and said mandrel, preferably said insulator comprises rubber. In one aspect, said rubber comprises a fiber and/or particulate. In one aspect, said fiber is a Kevlar, and/or carbon fiber. In one aspect, said particulate is silica.

7. A fiber reinforced polymer composite structure according to any of claims 4 to 6, comprising at least one ignitor and at least one nozzle, said at least one ignitor and said at least one nozzle being positioned opposite each other in at least one of said polar openings.

8. A process of making a fiber reinforced polymer composite structure, said fiber reinforced polymer composite structure comprising a mandrel, preferably said mandrel comprises a material selected from the group consisting of aluminum, rubber, a glass reinforced composite, a rocket propellant and mixtures thereof, wrapped via a filament winding process and/or a fiber placement process with at least one resin and at least one fiber to form a continuous circuit from said fiber, said fiber having an electrical resistivity of from about 1×10\hat{ }-2 ohm-cm to about 1×10\hat{ }-4 ohm-cm; said process comprising the step of curing said resin by applying, in a continuous or pulsed manner, a magnetic field that is generated by alternating current in the kHz regime to said fiber reinforced polymer composite structure until said at least one resin is cured, preferably said kHz regime is at least 50 kHz, more preferably said kHz regime from about 50 kHz to about 450 kHz. Optionally, said fiber reinforced polymer composite structure is cooled between pulses by passing a cooling fluid over said fiber reinforced polymer composite structure, preferably said cooling fluid is a gas, more preferably said gas is inert, most preferably said gas comprises nitrogen.

9. The process according to claim 8, wherein said magnetic field is generated by running said alternating current in the kHz regime through a coil, said coil comprising an internal passage through which a cooling fluid can be passed, preferably said coil has a conductivity of at least 4.5×10\hat{ }7 S/m, more preferably from about 4.5×10\hat{ }7 S/m to about 5.8×10\hat{ }7 S/m, most preferably from about 5.8×10\hat{ }7 S/m to about 6×10\hat{ }7 S/m.

10. The process according to claim 9, wherein said process employs at least one coil selected from the group consisting of a solenoid coil, an axial coil, a helical coil and a multi-axial coil.

11. The process according to claims 9 and 10, wherein said coil is translated over the surface of said fiber reinforced polymer composite structure.

12. The process according to any of claims 8 to 11, wherein said filament wound fibers are selected from the group consisting of polar fibers, helical fibers, hoop fibers, unidirectional zero degree fibers, braided sleeves, and mixtures thereof, preferably when said fiber reinforced polymer composite structure is a pressure containment vessel, said fiber reinforced polymer composite structure comprises hoop fibers, when axial stiffness is desired, said pressure containment vessel comprises polar fibers, helical fibers, unidirectional zero degree fibers, braided sleeves, and/or mixtures thereof.

13. The process according to any of claims 8 to 12 wherein and said at least one resin has a glass transition temperature of greater than 80° C., preferably greater than 200° C., more preferably from about 250° C. to about 400° C., most preferably from about 300° C. to about 400° C.

14. The process of making a fiber reinforced polymer composite structure according to any of claims 8 to 13, wherein
a) said resin is cured by a continuous magnetic field and said resin is selected from the group consisting of epoxies, benzoxazines, phthalonitriles, cyanate esters, bismaleimides and polyimides, preferably said resin is selected from the group consisting of epoxies, benzoxazines, cyanate esters, bismaleimides and mixtures thereof, more preferably said resin is selected from the group consisting of benzoxazines, cyanate esters, bismaleimides and mixtures thereof, more preferably said resin is selected from the group consisting of bismaleimides, cyanate esters and mixtures thereof, most preferably said resin comprises at least one cyanate ester; or
b) said resin is cured by a continuous magnetic field and said resin is selected from the group consisting of epoxies, benzoxazines, bismaleimides, cyanate esters and mixtures thereof, preferably said resin is selected from the group consisting of benzoxazines, bismaleimides, cyanate esters and mixtures thereof; more preferably said resin is selected from the group consisting of bismaleimides, cyanate esters and mixtures thereof; most preferably said resin comprises at least one cyanate ester.

15. The process of making a fiber reinforced polymer composite structure, according to any of claim 8 or 14, wherein said fiber reinforced polymer composite structure further comprises a mandrel comprising a rocket propellant, said mandrel having at least two ends and at least two polar openings that are on opposite ends of said fiber reinforced polymer composite structure, said at least one fiber and resin forming a casing that encases said mandrel except at said polar openings, preferably said rocket propellant's surface temperature is kept from reaching 60° C.

16. A process of making a fiber reinforced polymer composite structure, according to claim 15, wherein said rocket propellant is a solid propellant or a hybrid propellant or a liquid propellant.

17. A process of making a fiber reinforced polymer composite structure, according to any of claim 15 or 16, wherein said fiber reinforced polymer composite structure comprises an insulator that is positioned between said casing and said mandrel, preferably said insulator comprises rubber.

18. A process of making a fiber reinforced polymer composite structure, according to any of claim 15 or 17, wherein said fiber reinforced polymer composite structure comprises an least one ignitor and at least one nozzle, said an least one ignitor and said at least one nozzle being positioned opposite each other in at least one of said polar openings.

19. A process of making a fiber reinforced polymer composite structure, according to any of claims 8 to 18, said process comprising pulse curing of said at least one resin.

20. A process of making a fiber reinforced polymer composite structure, according to any of claims 8 to 19, wherein said fiber reinforced polymer composite structure is actively or passively cooled between said pulses.

21. A resin composition comprising:
a) a bismaleimide (BMI) preferably oligomerized from 4,4′-bismaleimidodiphenylmethane, bismaleimide BMI-1,3-tolyl, and o,o′-diallylbisphenol A, catalyzed with, based on total composition weight, from about 1% to about 5%, preferably about 2 percent of dicumyl peroxide or cumene hydroperoxide;
b) a bisphenol A dicyanate ester, catalyzed with from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a metal ion concentration derived from metal carboxylates or chelates such as zinc(II)naphthenate (from about 60 ppm to about 150 ppm Zn²⁺), zinc(II)acetylacetonate (about 60 ppm Zn²⁺), copper(II)acetylacetonate (from about 100 ppm to about 500 ppm Cu²⁺), copper(II)naphthenate (about 200 ppm Cu²⁺), cobalt(II)acetylacetonate (from about 170 to about 370 ppm Co²⁺), or cobalt(III)acetylacetonate (from about 120 to about 360 ppm Co³⁺), preferably said metal chelate is selected from the group consisting of copper(II)acetylacetonate, cobalt(III)acetylacetonate and mixtures thereof;
c) a bisphenol E dicyanate ester, catalyzed with from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a total of about 50 ppm to about 360 ppm of Cu²⁺ or Co³⁺ metal ion concentration derived from metal chelates, preferably said metal chelates are selected from the group consisting of copper(II)acetylacetonate, cobalt(III)acetylacetonate, and mixtures thereof;
d) a bisphenol A dicyanate ester, catalyzed with m-cresol at a concentration from about 0.75 phr to about 6 phr, and from about 50 ppm to about 360 ppm of Cu²⁺ or Co³⁺ metal ion concentration derived from metal chelates, preferably said metal chelates are selected from the group consisting of copper(II)acetylacetonate,
cobalt(III)acetylacetonate, and mixtures thereof;
e) a bisphenol E dicyanate ester, catalyzed with m-cresol at a concentration from about 0.75 phr to about 6 phr, and from about 50 ppm to about 360 ppm of Cu²⁺ or Co³⁺ metal ion concentration derived from metal chelates, preferably said metal chelates are selected from the group consisting of copper(II)acetylacetonate, cobalt(III)acetylacetonate, and mixtures thereof;
f) a bisphenol A dicyanate ester, a novolac cyanate ester, said bisphenol A dicyanate ester, and novolac cyanate ester, being present in a mass fraction ratio of from about 0.7:0.3 to about 1:1, from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a total of from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof;
g) a bisphenol E dicyanate ester, a novolac cyanate ester, said bisphenol E dicyanate ester, and novolac cyanate ester, being present in a mass fraction ratio of from about 0.7:0.3 to about 1:1, from about 0.5 phr to about 1.99 phr nonylphenol, preferably from about 0.75 phr to about 1.9 phr nonylphenol, more preferably from about 1 phr to about 1.8 phr nonylphenol, more preferably from about 1.25 phr to about 1.7 phr nonylphenol, most preferably from about 1.5 phr to about 1.6 phr nonylphenol, and a total of from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof;
h) a bisphenol A dicyanate ester, a novolac cyanate ester, said bisphenol A dicyanate ester, and novolac cyanate ester being present in a mass fraction ratio of from about 0.7:0.3 to about 1:1, catalyzed with about 0.75 phr to about 6 phr m-cresol and from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof; or
i) a bisphenol E dicyanate ester, a novolac cyanate ester, said bisphenol E dicyanate ester, and novolac cyanate ester being present in a mass fraction ratio of from about 0.7:0.3 to about 1:1, catalyzed with about 0.75 phr to about 6 phr m-cresol and from about 50 ppm to about 360 ppm of Cu2+ or Co3+ metal ion concentration derived from metal chelates, preferably said metal chelates are selected from the group consisting of copper(II)acetylacetonate, cobalt(III)acetylacetonate, and mixtures thereof.
